(19) United States
(12) Patent Application Publication
(10) Pub. No.: US 2014/0000148 A1
(43) Pub. Date: Jan. 2, 2014

(54) FISHING LURE WITH HOOK MOUNT ASSEMBLY

(71) Applicant: Paul Allen Signitzer, Hervey Bay (AU)

(72) Inventor: Paul Allen Signitzer, Hervey Bay (AU)

(21) Appl. No.: 13/928,392

(22) Filed: Jun. 27, 2013

Related U.S. Application Data
(60) Provisional application No. 61/666,850, filed on Jun. 30, 2012.

(51) Int. Cl. A01K 85/02

(52) U.S. Cl. CPC A01K 85/02
USPC 43/4.5; 43/42.44

(57) ABSTRACT

A fishing lure including a body and a mounting assembly configured to releasably hold a hook array to the body. The mounting assembly includes an eye retainer for pivotally retaining an eye of the hook array, and a catch spaced from the eye retainer, the catch adapted to engage two shafts of the hook array. The catch is shaped to engage and release the hook array subsequent to elastic relative movement between the two shafts. The eye retainer maybe any suitable shape permitting loading of the hook. The catch may include a contact section positioned for first contact with a hook array when loading onto the catch, and a retention section for positioning of the hook array when loaded.

### TECHNICAL FIELD

The present invention relates generally to fishing lures, and more particularly to arrangements for connecting hooks to lures, jig heads, hooks and other artificial baits.

### BACKGROUND

Fishing lures, jig heads and hooks are devices used by attaching them to a fishing line with one or more fish hooks attached to the lure in such a way that a fish biting on the lure is likely to be caught on the fish hooks.

It is known to utilise hook arrays comprising one (“singles), two (“doubles”), three (“trebles”) four (“quad”) or more hooks arranged on a common eye. The eye allows attachment to a fishing line or directly to a lure. One advantage of multiple hooks in arrays is that they increase the prospects of successfully catching and retaining a fish.

They do, however, have some disadvantages. One notable problem is that an increased number of hook points and barbs increases the likelihood of “snagging” the lure. This leads to an interruption in fishing and also a high chance of losing terminal tackle including the lure, which is often reasonably expensive. Free rotating hook arrays also tend to tangle in their attached line leading to elimination of the lure's proper function on a cast and retrieve and sometimes permanent line twist.

### SUMMARY

In one form but not the only or necessarily the broadest form, the invention may reside in a fishing lure with one or more mounting assemblies for hooks, the fishing lure comprising;

a body; and

a mounting assembly configured to releasably hold a hook array coupled to the body, the mounting assembly comprising an eye retainer for pivotally retaining an eye of the hook array, and a catch spaced from the eye retainer, the catch adapted to engage two shafts of the hook array; wherein

the catch is shaped to engage and release the hook array subsequent to elastic relative movement between the two shafts.

The body may be any suitable shape. The body may, without limitation, comprise a hard body, soft body, a jig head, spinner bait, a blade, a spoon, a hook or portion thereof adapted alone or in combination with another element to act as a bait or a platform for catching fish, or any other artificial device used for the purpose of catching fish. The body may be formed from any suitable material. Examples of suitable material include metal, polymeric materials such as soft or hard plastics, timber and epoxy resins.

The eye retainer may be any suitable configuration. The eye retainer may be in the form of a hole, open loop, closed loop, ring, eyelet, clasp or clip or similar, through which the eye of a hook array can pass and locate. The eye retainer may be suitable to receive a second eye, the second eye being part of a second hook array with two hook arrays connected to the one eye retainer.

The eye retainer may be in the form of a closed loop that extends from the lure body. In a further embodiment, the eye retainer may be in the form of a hole or slot in the lure body.

The eye retainer may be in the form of an open loop which is shaped to permit a hook array to be guided onto the open loop but which prevents the hook array from readily disengaging from the hook eye retainer, particularly when a fish is hooked. The open loop may include a bent metal wire that may be prised open to allow the hook eye to fit into the hook eye retainer. The open loop may include a bent metal wire that includes a bend configuration that inhibits the likelihood of the hook eye from returning back in the direction of initial engagement to the hook eye retainer.

The eye retainer may include a wire clasp movable to an open position to permit passage of an eye of the hook array and then movable to a closed position to prevent the hook array from breaking free from the eye retainer.

The catch may include a contact section positioned for first contact with a hook array when loading onto the catch, and a retention section for positioning of the hook array when loaded.

The contact section is preferably wider than the inter shaft distance of the two shafts that locate over it and the retention section is however then the contact section.

The contact section may be one or more ledges, a cone-shaped head, a wire, a plate or any other structure that requires “springing” of two shafts of the hook array apart in loading.

The retention section may be an area that is narrower than the contact section. It may be a slot, a hole, a recess, a thinner plate, a waist, or other suitable shape.

In one form, the catch may be a thin plate or wire to allow a compressive fit of the two shafts.

The catch may be in the form of a retaining edge which engages with the hook shafts by elastic deformation of at least one of the shafts and separation by relative movement of the shafts. Hook arrays are usually formed from steel or stainless steel or other rigid material that has an inherent resilience. The shafts are continuous with the eye and can be compressed towards each other or pulled away from each other, thereby causing relative movement between the shafts. It is preferred there be at least one shaft that is not welded to the other shafts to permit the inherent resilience required to engage the catch. On release, assuming they have not been permanently distorted, they will resume their original position due a resilient bias to do so. When force is applied to one or more hooks of the hook array, spring resilience between the shafts may be overcome and the hook shafts can engage with or disengage from the catch due to relative movement between the shafts. The hook array remains pivotally connected to the fishing lure via the eye retainer element.

The catch may be in the form of a wire loop such that the parallel shafts of the hook array engage with the wire loop. The catch may be formed as a button having a head and waist, the head dimensioned to allow passage of the shafts when separated to retain the shafts in the waist after engagement.

Alternatively the catch may be configured with a retaining profile that includes at least one retaining edge wider than the gap that separates the hook shafts.

Further alternatively, the catch may include a hole, groove or slot in the lure body. In another form the catch may have lips spaced to allow passage of the shafts when compressed towards each other and retain the hook array when the shafts are released.

The catch can be made from any suitable material including wire, shaped metal, or moulded plastic. It may be mounted to the body or formed integrally as part of the lure body. The catch can be on one part of the lure and eye retainer on a separate part of the lure. It is preferable for the catch to be made from a rigid material rather than a soft plastic material to ensure the hook array is forcibly retained within the catch. The rigid material will not flex to release the hook array, requiring a higher level of force to disengage the hook array than an equivalent catch made from a soft plastic material. The increased retention force arising from the rigid catch increases the likelihood of a fish striking at the artificial bait or lure to be hooked, as it requires greater force to dislodge the hook from the catch, ensuring a more positive connection. The rigid material is also less likely to tear than soft plastic materials engaging with rigid metal hook arrays.

The eye retainer and catch or catches may be aligned along a front to rear axis on the body. Either the eye retainer or a catch may be anterior on the body.

The eye retainer and catch may be connected by and positioned on an arm which in turn is attached to the body. The eye retainer, arm and catch may be integrally formed. The eye retainer and catch may be on the body or alternatively, the eye retainer and/or catch may be on the arm and spaced from the body. This embodiment is of particular use with a jig head body or worm hook body for use with soft plastics lures. In one embodiment, an arm may be adapted to incorporate catches and/or eye retainers for two or more hook arrays. The location of additional hook arrays to a jighead increases the likelihood of catching a fish that strikes at the bait mounted to the jighead. The separation of the eye retainer, arm and catch away from the soft plastic bait ensures that the action of the bait is unaffected by the additional hook array fitment.

The body may include one, two or more mounting assemblies. The body may include three mounting assemblies. The body can be a hook.

The fishing lure may further include at least one hook array. The hook array preferably includes at least 2 shafts that are substantially parallel, although other shapes may also be utilised. It is preferred that the shafts are not welded or, if welded, the position of the weld is such as to retain distal relative flexibility of the shafts. The hook array may be made from a sprung material and biased to retain the shafts in close proximity to each other or even touching or approaching each other at some point along the length of the shaft. The hook array may have one, two, three, four or more hooks. The two hook array may have diametrically opposed hooks. Alternatively the hooks may be angled to each other.

The hook array may comprise shafts that are spaced apart and at least one protrusion on a shaft for enhancing contact with the catch. Preferably each of two shafts has a protrusion and they may be mirror images of each other. Each protrusion may be formed by an inward or outward deviation of a corresponding shaft.

The hook can be shaped to closely follow the contour of the lure body or engage with the lure body at a location with the lure body performing the role of the catch.

The hook array may include a guard positioned at or around the eye, the guard dimensioned to shield, at least in part, a corresponding gape of a hook on the array. In operation the guard shields the corresponding gape when it trails the guard. Preferably a guard is provided for each hook gape on the array. The guard can be fitted connected to the eye retainer or hook eye via a friction or adhesive fitment. The guard may be substantially wing or fin shaped.

In a further aspect, the invention may reside in hook array substantially as described above.

In yet a further aspect the invention may reside in a method of releasably loading a hook array onto a lure, the method comprising the steps of:

positioning an eye of the hook array in an eye retainer of the lure,

releasably loading the hook array on a catch of the lure by separating two shafts of the hook array; positioning the two shafts over a portion of the catch and

allowing the two shafts to resiliently return towards each other and engage the catch.

The catch being made of a sufficiently resilient material that it will not flex to permit the easy release of the hook array from the catch.

It can be the shafts and or the start of the hook bend that is retained on the catch.

### BRIEF DESCRIPTION OF THE DRAWINGS

Features of preferred embodiments of the invention are described hereinafter, by way of example only, with reference to the accompanying drawings in which:—

FIG. 1a is a front view, side view and top view of a single hook.

FIGS. 1b-1d are front view, side view and top views of hook arrays.

FIGS. 2a-2d are front view and sectional views of a hook array including connection to a fishing lure body.

FIGS. 2e-2g are side views of hook arrays showing eye location angle variations

FIGS. 3a-3e are front view and sectional views of a hook array including connection to a lure body

FIGS. 4a-4l are side view of variations of the hook eye retainers and hook catches

FIGS. 5a-5e are detail side and front views of catches

FIGS. 6a-6f are side, top and perspective views of a spoon or metal type lure including hook eye retainer and catch hook mount assemblies

FIGS. 7a-7d are perspective views of blade type lures including hook eye retainer and catch hook mount assemblies and guard

FIGS. 8a-8b are perspective views of lipless, bibless and lipped or bibbed hard bodied type lures including hook eye retainer and catch hook mount assemblies

FIGS. 9a-9b are perspective and side views of jig head style lures including hook eye retainer and catch hook mount assemblies

FIG. 9c is a perspective view of a swinging jig head including hook eye retainer and catch hook mount assemblies

FIG. 9d is a perspective view of a worm hook including hook eye retainer and catch hook mount assemblies

FIG. 9f is a side view of a jig head assembly including more than one hook eye retainer and catch hook mount assemblies

FIG. 9g-i are side views and perspective views of a jig head assembly including one hook eye retainer and catch hook mount assemblies

FIGS. 10a-10c are perspective views of jig head lures including hook eye retainer and catch hook mount assemblies

FIGS. 11a-11c are perspective views of jig head, worm hook and swinging jig head style baits with tails including hook eye retainer and catch hook mount assemblies

FIG. 12a-12c are front and end views of guards that can be fitted to the hook eye or eye retainer

FIG. 13a-13d are top and side views of alternative jig head assemblies that include hook eye retainer and catch hook mount assemblies

### DETAILED DESCRIPTION OF DRAWINGS

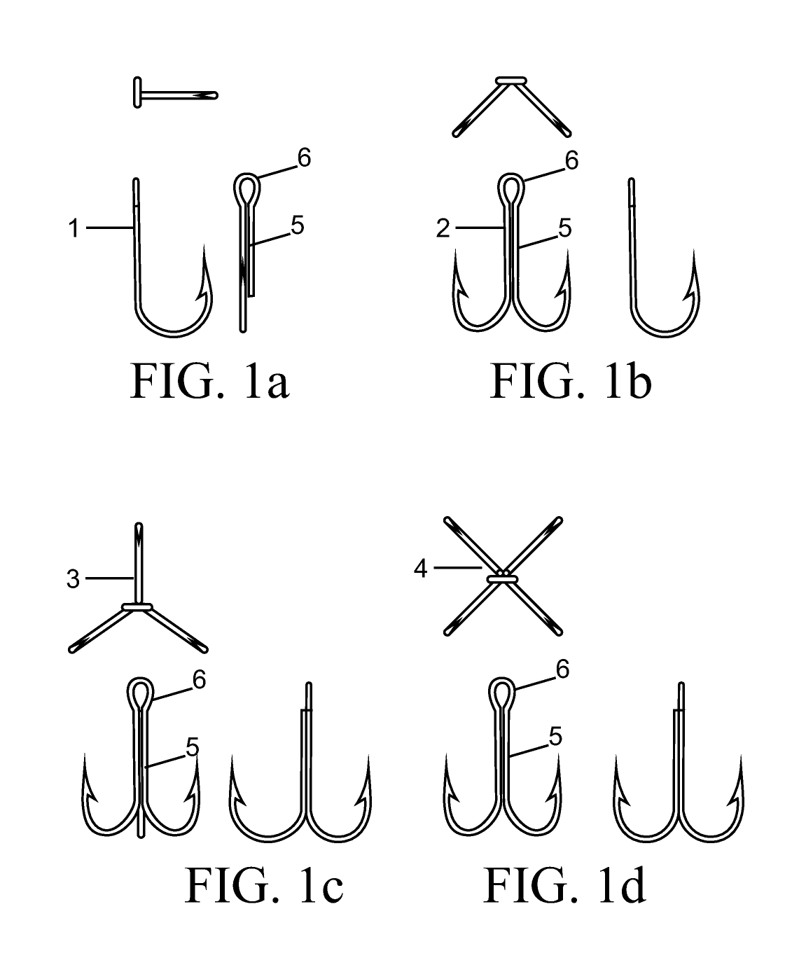

FIG. 1a shows a single hook array, which can be referred to as a single 1. FIG. 1b shows a hook array that includes 2 hook shafts and barbs and is commonly referred to as a double hook 2. FIG. 1c shows a hook array that includes 3 hook shafts and barbs and is commonly referred to as a treble hook 3. FIG. 1 d shows a hook array that includes 4 hook shafts and barbs and is commonly referred to as a quad hook 4. In each case the hook arrays are attached to shafts 5 that are generally substantially parallel and are connected to a common eye 6. The hook eye 6 permits attachment to a fishing line or directly to a lure, jig head or other fishing apparatus. A standard double hook array has shafts that are not welded. For the present invention a treble or quad hook configuration preferably has at least one shaft that is not welded to the other shafts which will permit the inherent resilience required to engage the catch. Alternatively if welded, the weld may be sited near the eye leaving a flexible shaft area towards the gape of the hook.

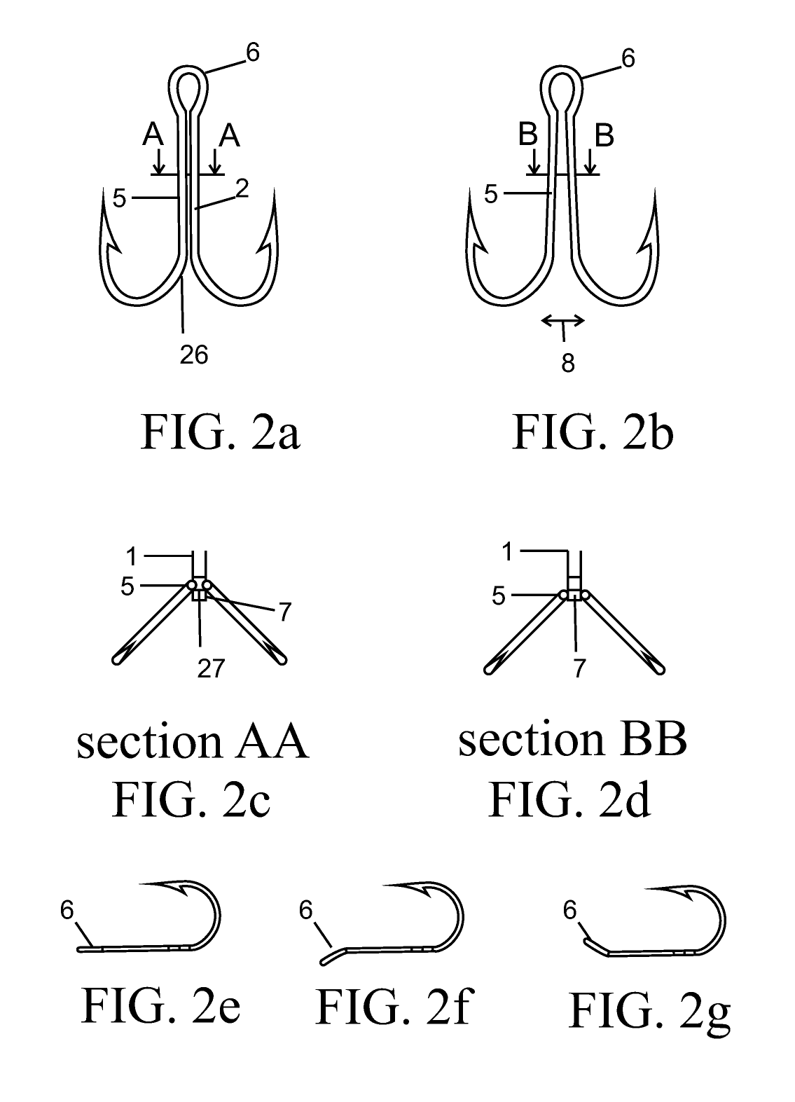

FIG. 2a shows a double hook 2. When a force 8 is applied to the hook shafts 5 as shown in FIG. 2b, there is elastic relative movement of the hook shafts 5, that biases the hook shafts 5 to return to the neutral position as shown in FIG. 2a. When the hook shafts 5 are prised or flexed open they can engage with a catch 7, adapted to retain the hook shafts 5 of the hook array as demonstrated in FIGS. 2c and 2d. The catch 7 forms part of the mounting assembly for the hook array. FIGS. 2e-g demonstrate that the hook eye 6 can be in alignment to the shaft 5 or be bent towards or away from the hook array depending on the preferred configuration.

Hook arrays such as double hooks that are commonly available include a gap between the shafts of the hook that varies from 0 mm to approximately 1 mm.

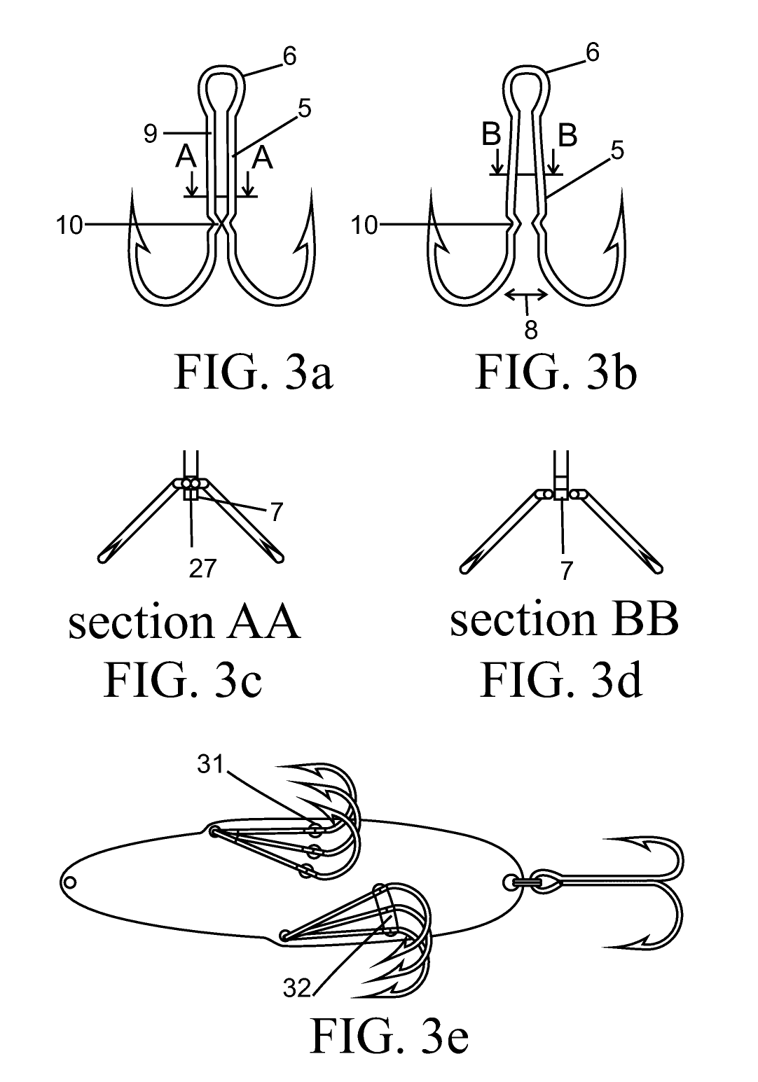

FIG. 3a shows an alternative arrangement of a double hook array 9, with the hook shafts 5 substantially parallel and spaced apart. The spacing allows for locating the hook relative to lure bodies that have thickness, permitting the hook shafts 5 to be located over or within the lure body as shown in FIG. 3e. The hook shafts 5 can include a protrusion 10 in the form of an inward deviation on the shafts 5 of the hook. These protrusions 10 are spaced closer than the hook shafts such that they can engage via a frictional force on the lure body including engagement with a series of holes 31, slots 32 or grooves to hold the hook in a temporary position relative to the lure body. This feature permits the angler to predetermine the best location for the hook in accordance with the fishing conditions. For instance, if fishing a waterway that includes numerous underwater obstacles or ‘snags’, the angler can choose to locate the hook with the barbs closer to the lure body to avoid snagging, whilst in open water, the hooks may be adjusted for maximum exposure and the greatest chance of hooking a fish. Double hook arrays in this configuration could include a gap between the shafts of the hook that varies from 1 mm to approximately 5 mm with the protrusions closing the gap to less than 2 mm depending on the lure body thickness and catch arrangement they are being mounted to, although this range is not limiting.

When a force 8 is applied to the hook shafts 5, there is elastic relative movement of the hook shafts 5, that biases the hook shafts 5 to return to the neutral position as shown in FIG. 3a. When the hook shafts 5 are prised or flexed open they can engage with a catch 7, adapted to retain the hook shafts 5 of the hook array as demonstrated in FIGS. 3c and 3d.

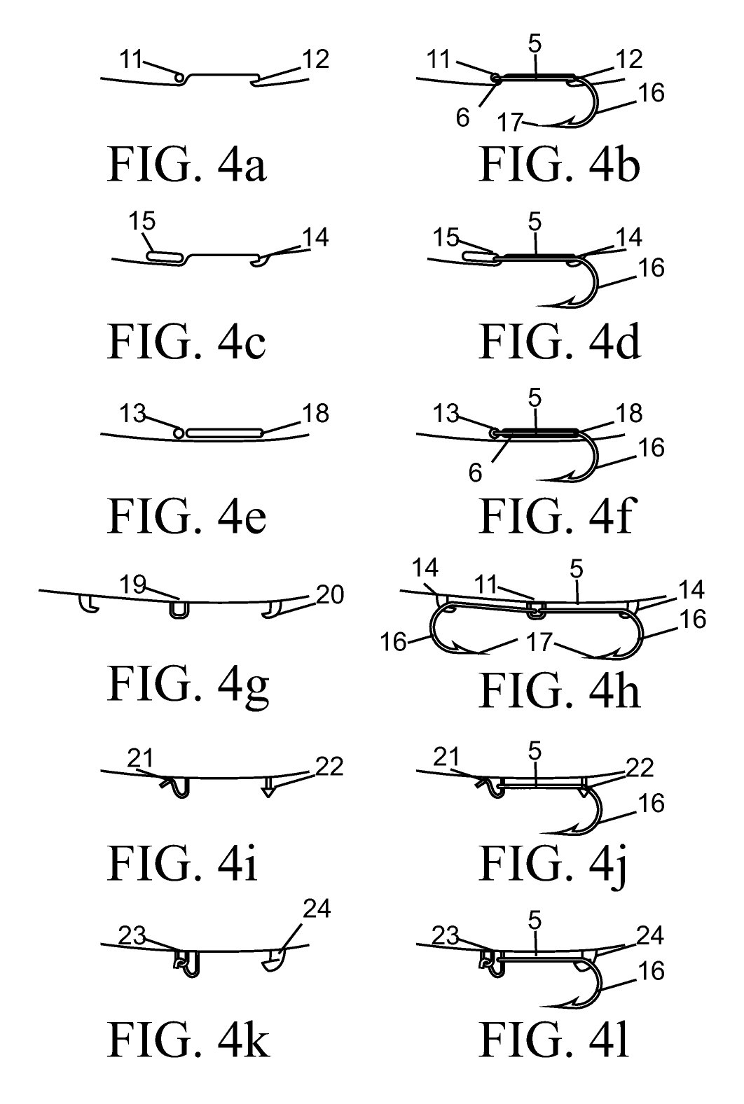

As shown in FIG. 4, the mounting assembly for mounting the hook array 16 to the lure body comprises an eye retainer 11 for pivotally retaining an eye 6 of the hook array 16 and a catch 12 spaced from the eye retainer 11, the catch 12 adapted to engage two shafts 5 of the hook array. The eye retainer 11 may be in the form of a hole 13, elongated hole or slot 15, closed loop 19, open loop 21, ring, eyelet, clasp or clip 23 or similar, through which the eye of a hook array 16 can pass and locate. The eye retainer may also receive a second eye, the second eye being part of a second hook array with two hook arrays connected to the one eye retainer as shown in FIG. 4h. In this configuration the hook array that is in the forward position when the lure is pulled forward in the water has its hook points 17 facing away from the direction of line pull such that the hook array is unlikely to become tangled or snagged on underwater obstacles. This front hook array can also act as a guard to stop the additional hook array from snagging on underwater obstacles. In some instances such as in a fish lure configuration of the invention, the forward hook can be close to the head of the lure. The location of a hook array near the head of the lure can be a useful addition for increasing predatory fish capture. Some predatory fish when consuming a fish bait prefer to swallow it from the head first as all of the spines on the bait face towards the back. If eaten in this manner, it is less likely for the bones and fins of the bait to catch on their way through the predatory fish's digestive tract. When an angler feels that a fish has struck the bait, the line is generally pulled, engaging the hooks more forcibly into the fish's mouth and throat.

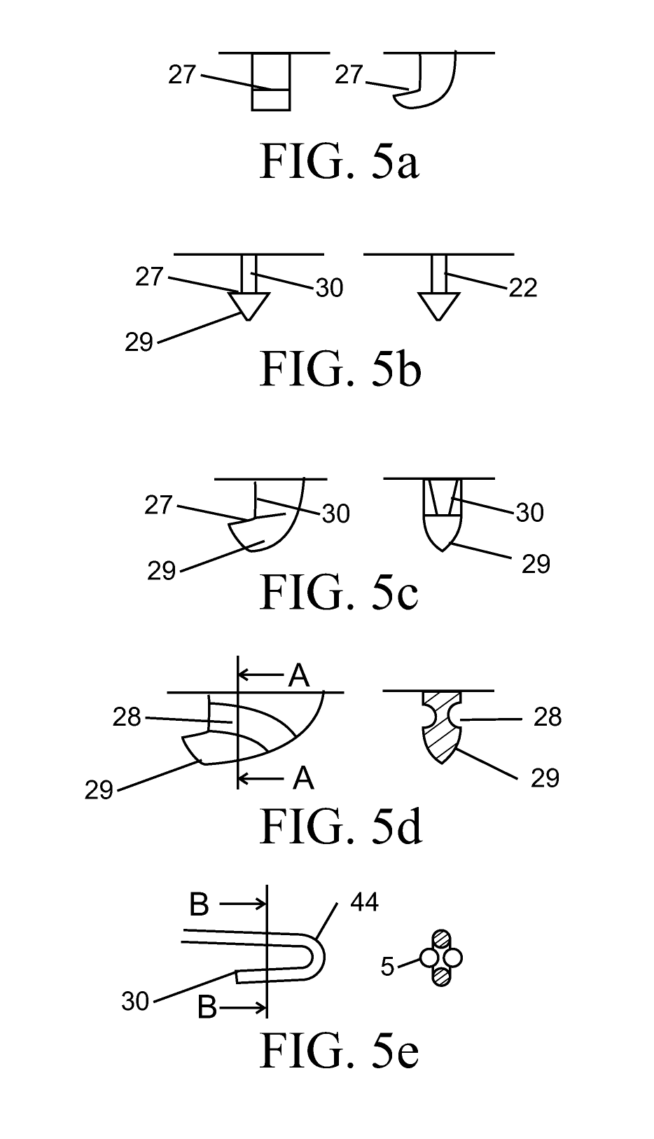

In one arrangement as shown in FIG. 4b, the hook eye retainer can be in the form of a hole 11. The eye retainer 11/13, permits the angler to connect one or more hook arrays to the fishing lure. The hook array 16 includes at least one continuous band of metal from the point of the hook 17 to the hook eye 6. The angler is able to add or remove hooks to the fishing lure by guiding the point of the hook through the eye retainer 11 and sliding the hook through until the hook eye 6 is engaged with the eye retainer 11. The eye retainer 11 is preferably sufficiently small in wall thickness from its edge to allow for the elastic resilience force of the hook to spread sufficiently to engage the hook eye in place, preferably without permanently deforming or distorting the shape of the hook. A catch 12 is spaced from the eye retainer 11/13 such that the hook array 16 engages with the catch 12 releasably holding the hook array 16 in place until such time that the lure is struck by a fish. When the hook is engaged by a predatory fish strike, the hook shafts 5 can break free from the catch 12, such that the hook array 16 remains connected to the lure via the eye retainer 11. The contact section 29 as shown in FIG. 5c is conically shaped to automatically spread the shafts as they urge toward the retention section 27.

The eye retainer 15 can be in the form of a circular or elongated hole or slot. The shape of the eye retainer can be shaped in any format provided it allows the hook array to be fitted to the eye retainer.

The eye retainer 13 can be in combination with an elongated hole 18 which acts as the catch for the hook array 16 as shown in FIGS. 4e and 4f. The hook shafts 5 locate into the elongated hole to retain the hook array 16. In this configuration the transition area from the hook eye 6 to the hook shaft 5 can be forced to endure a significant frictional engagement with the lure body and or elongated hole 18 to engage the hook array into place on this catch arrangement. The closest edge of the elongated slot 18 to the eye retainer 13 may be reduced in width to minimise this frictional engagement force.

The eye retainer may be in the form of a closed loop 19 that extends from the lure body. The loop can be elongated or shaped to receive one or more hook arrays.

The eye retainer may be in the form of an open loop 21 which is shaped to permit a hook array to be guided onto the open loop but which prevents the hook array from readily disengaging from the hook eye retainer, particularly when a fish is hooked. The open loop may include a bent metal wire 21 that may be prised open to allow the hook eye to fit into the hook eye retainer. The open loop may include a bent metal wire 21 that includes a bend configuration that inhibits the likelihood of the hook eye from returning back in the direction of initial engagement to the hook eye retainer. The open loop 21 provides an alternative method for securing the hook array to the fishing lure in addition to the possible option of guiding the hook from the point, along the shaft and engaging the hook eye 6 with the eye retainer loop 21.

The eye retainer may include a wire clasp 23 movable to an open position to permit passage of an eye of the hook array and then movable to a closed position to prevent the hook array from breaking free from the eye retainer. This configuration can ideally be prised open with the use of fingers or pliers for easy engagement of the hook eye 6 to the eye retainer 23.

The catch 12 may be in the form of a retaining edge which engages with the hook shafts by elastic deformation of at least one of the shafts 5 and separated by relative movement of the shafts 5. Hook arrays are usually formed from steel or stainless steel or other rigid material that has an inherent resilience. The shafts are continuous with the eye and can be compressed towards each other or pulled away from each other, thereby causing relative movement between the shafts. On release, assuming they have not been permanently distorted, they will resume their original position due a resilient bias to do so. When force is applied to one or more hooks of the hook array, spring resilience between the shafts may be overcome and the hook shafts can engage with or disengage from the catch due to relative movement between the shafts. The hook array 16 remains pivotally connected to the fishing lure via the eye retainer element 11.

The relative location of the eye retainer 11 to the catch 12 should be gauged at specific lengths to correspond to specific hook array configurations. Different hook manufacturers make hooks with varying metal properties, hook eye shapes, length, gauge (wire thickness), gape and barbs. With double hook arrays used for fishing, the hook shafts generally run parallel from the eye up until a point where they bend 26 (FIG. 2a) into the main curve of the hook, which can be angled outwards between 15 and 90 degrees. Depending on the size or scale of the hook, the last 1 to 10 mm of the hook shaft and the first 3 to 5 mm of the bends are the good locations for the catch 12 to engage with and retain the hook. For the catch 12 to work most effectively, the distance between the hook eye retainer 11 and the catch 12 should allow for the area of the hook described above to engage the catch 12.

Alternatively the catch 12, 14, 18, 20, 22, 24 may be in the form of a shaped retaining profile that includes at least one retaining edge or structure wider than the gap that separates the hook shafts. The retaining edge of the catch 12, 18 can be retained within the body line of the fishing lure so that the edge does not protrude from the lure body.

In an alternative arrangement the catch 14, 20, 22, 24 can be in the form of a protruding profile which includes a retaining edge that is part of an extension that projects away from the lure body. The catch 14, 20, 22, 24 includes at least one retaining edge that is wider than the gap between the hook shafts 5 or the width of the start of the hook bends 26, such that the spring resilience of the hook material can be opened to engage into the retaining edge 27 (FIGS. 5a-e) of the hook retainer.

In a preferred configuration the head of the contact section 29 of the catch 12, 14, 20, 22, 24 can be of a reduced width relative to the retaining edges 27, such that minimal force is required to engage the separation of the hook shafts 5 which spread outwards before springing inwards to engage behind the retaining edges 27. The catch may be formed as a button 22 having a head 29 of the contact section and waist 30 as retention section, the head dimensioned to allow passage of the shafts when separated to retain the shafts in the waist 30 after engagement. The catch has a contact section 30 positioned for first contact with the hook array shafts 5 when loading the hook array on to the catch. The shafts are elastically deformed and then released to engage retention section 27. The shafts may be prised apart manually or the contact section may be shaped to facilitate separation of shafts as they are urged over the contact section 29. FIG. 2D shows the position of the shafts when engaging or releasing from the catch.

In another configuration of the catch, the retaining edge/edges 28 can be shaped to follow the line of the hook path as it curves into the hook bend, engaging with the hook over a greater frictional length for improved retention of the hook.

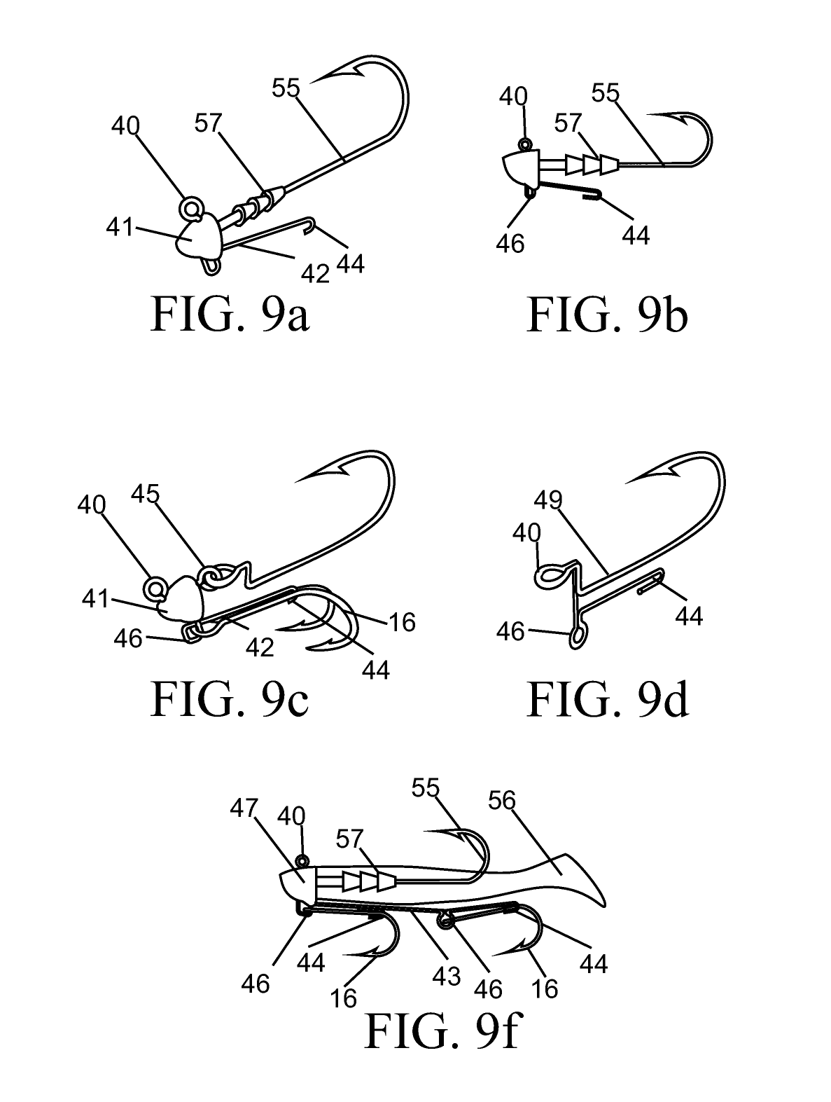

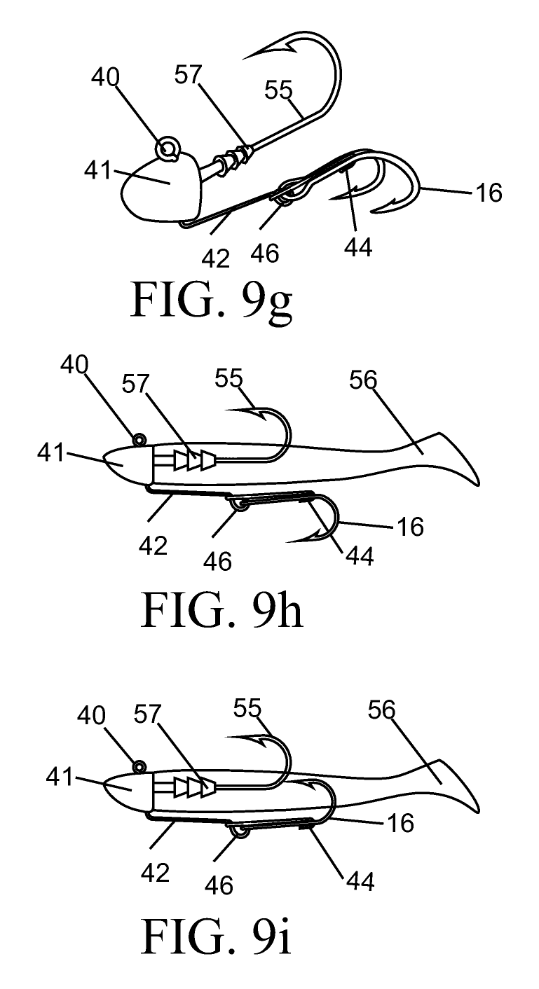

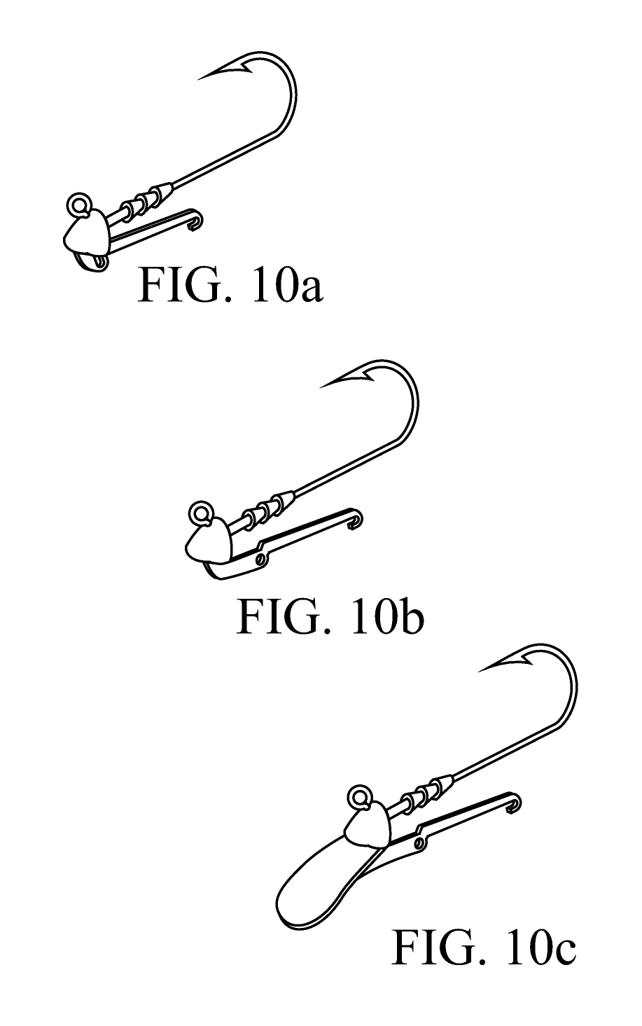

The catch may be in the form of a wire loop 44 such that the parallel shafts of the hook array engage with the wire loop 44. The wire loop catch 44 can be connected to a fishing lure or jig head 33, swinging jig head 45 or worm hook 49 application (FIGS. 9a-9i, 10a-c, 11a-c).

The catch in this case is preferably made from a rigid material rather than a soft plastic material to ensure the hook array is forcibly retained within the catch. The rigid material will not flex to release the hook array, requiring a higher level of force to disengage the hook array than an equivalent catch made from a soft plastic material. The increased retention force arising from the rigid catch increases the likelihood of a fish striking at the artificial bait or lure to be hooked, as it requires greater force to dislodge the hook from the catch, ensuring a more positive connection.

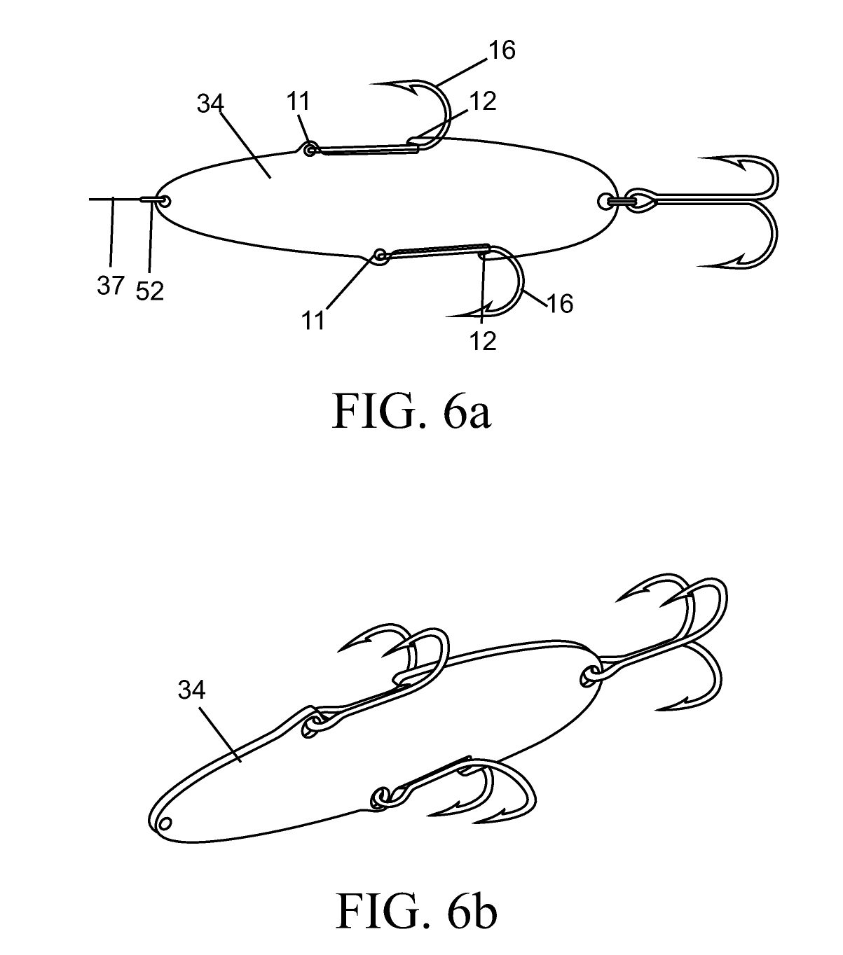

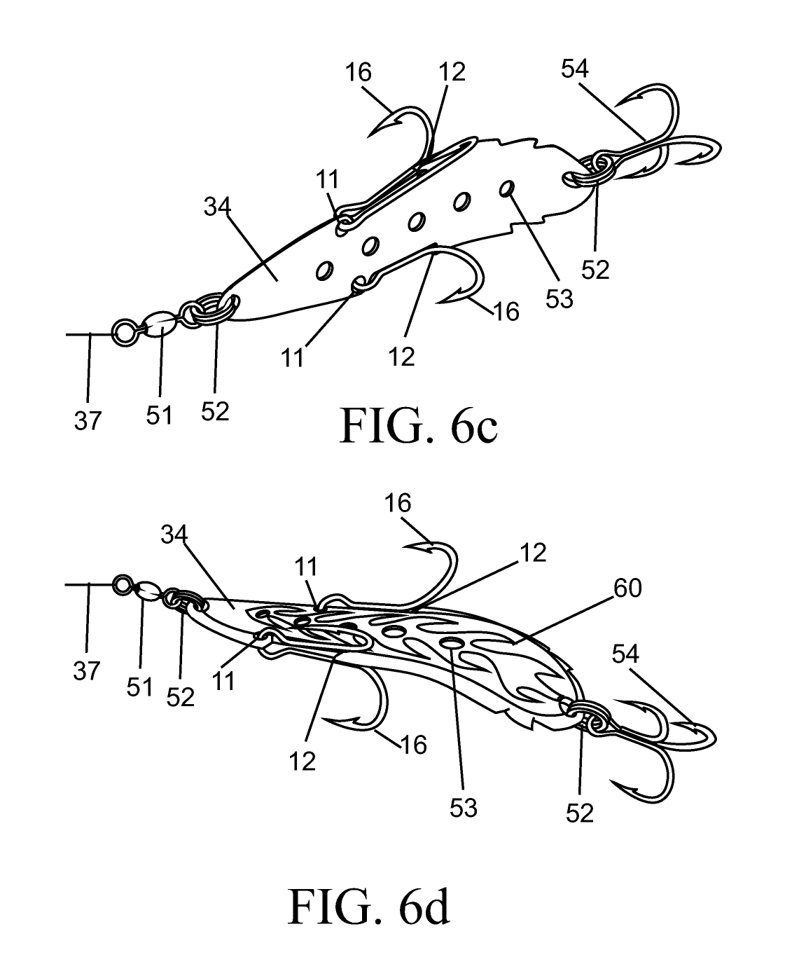

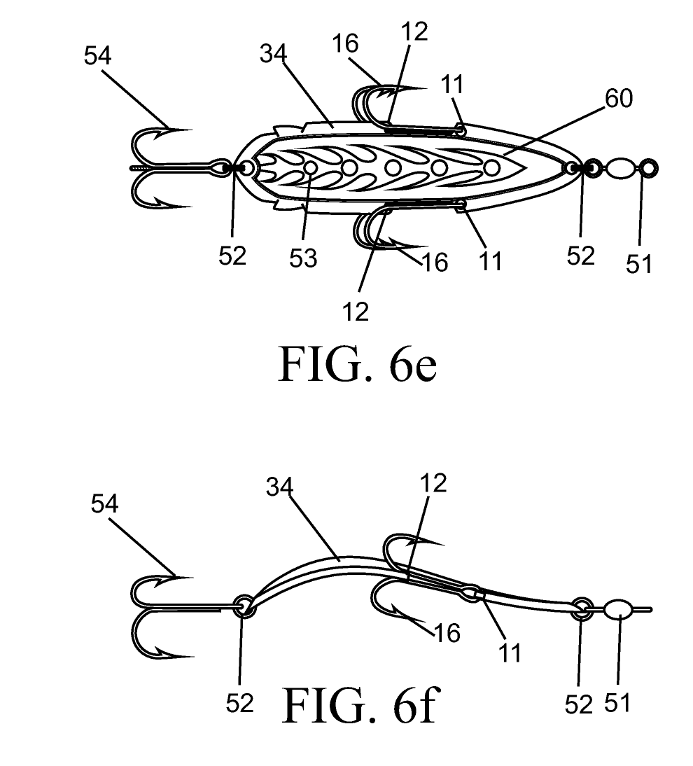

One fishing lure type is a spoon or metal lure 34, (FIGS. 6a-f) often used for high speed retrieves or trolling to simulate bait fish that attract predatory fish species. The lure is generally made of cast and or pressed metal having weight to assist with casting distance.

Spoons and metal lures 34 are generally fitted with a split or solid rings 52 and one hook array 54 connected to the rear of the lure 34. The spoon or metal lure 34 can include split or solid rings 52 for connecting a swivel 51 and or line 37 to the front of the spoon or metal lure 34. One or more eye retainers 11 and catches 12 can be included in the lure configuration. The mounting of additional hook arrays 16 to the lure increases the likelihood of a predatory fish being hooked on the hook arrays 16 when they strike at the lure. The hook arrays 16 are retained releasably relative to the lure body 34 in general fishing conditions such that the hook arrays 16 are not free swinging. This feature offers the advantage of minimising the potential for the hooks to become entangled in the line 37 used to pull the lure. The spoon or metal lure 34 can include holes 53 along its body to cause turbulence and bubbles as the spoon or metal lure 34 moves through the water, an additional attractant to predatory fish. The spoon or metal lure 34 can also include rattle chambers and or flavour or attractant chambers to add to the spoon or metal lure's 34 attractiveness to fish. Markings can be applied to the spoon or metal lure 34 in the form of holographic or reflective decals or stickers 60 to increase the attractiveness of the spoon or metal lure 34 to fish.

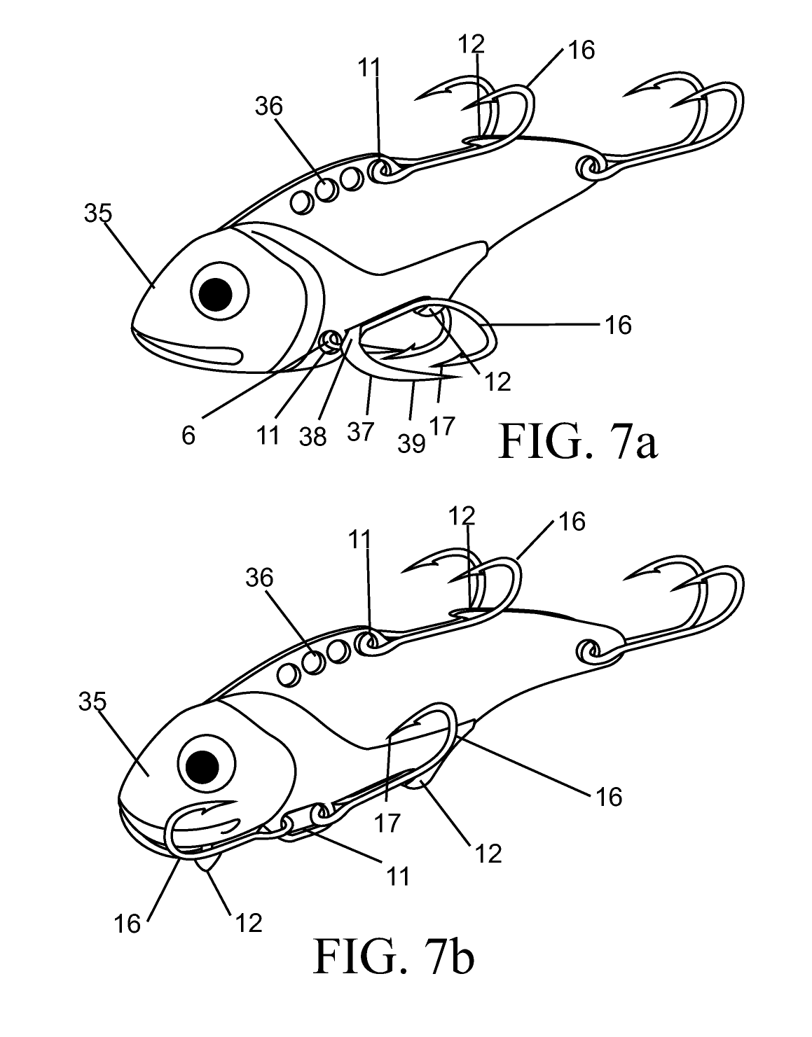

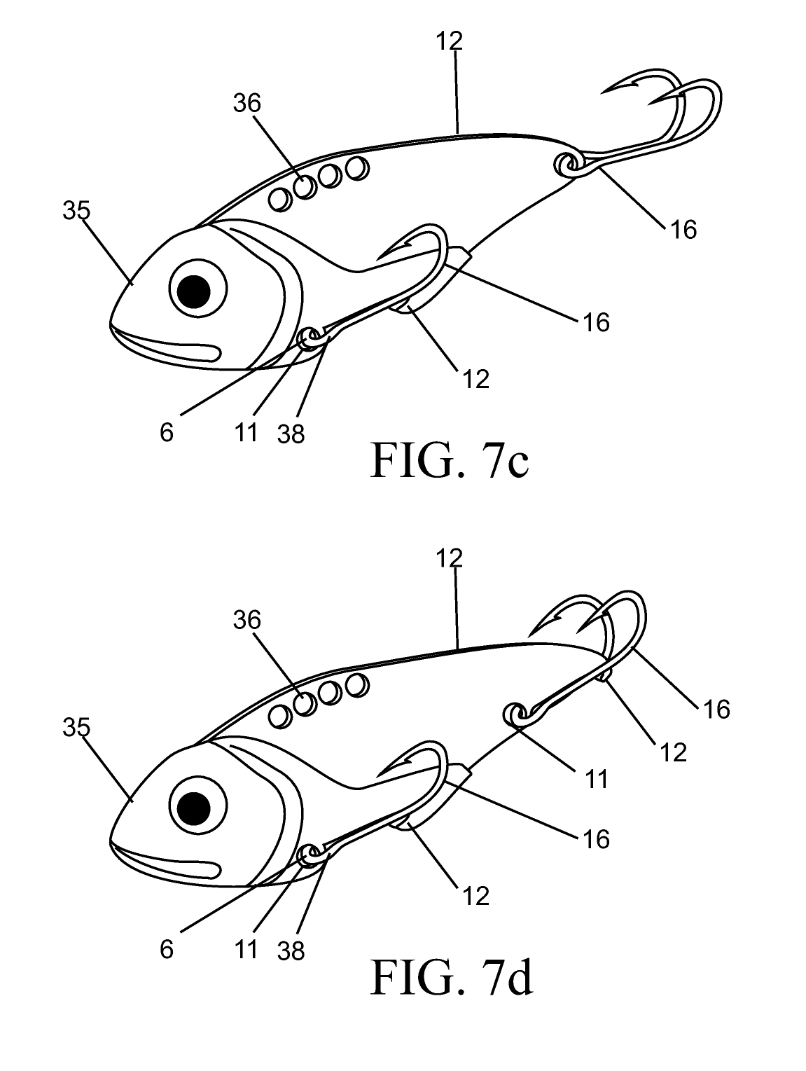

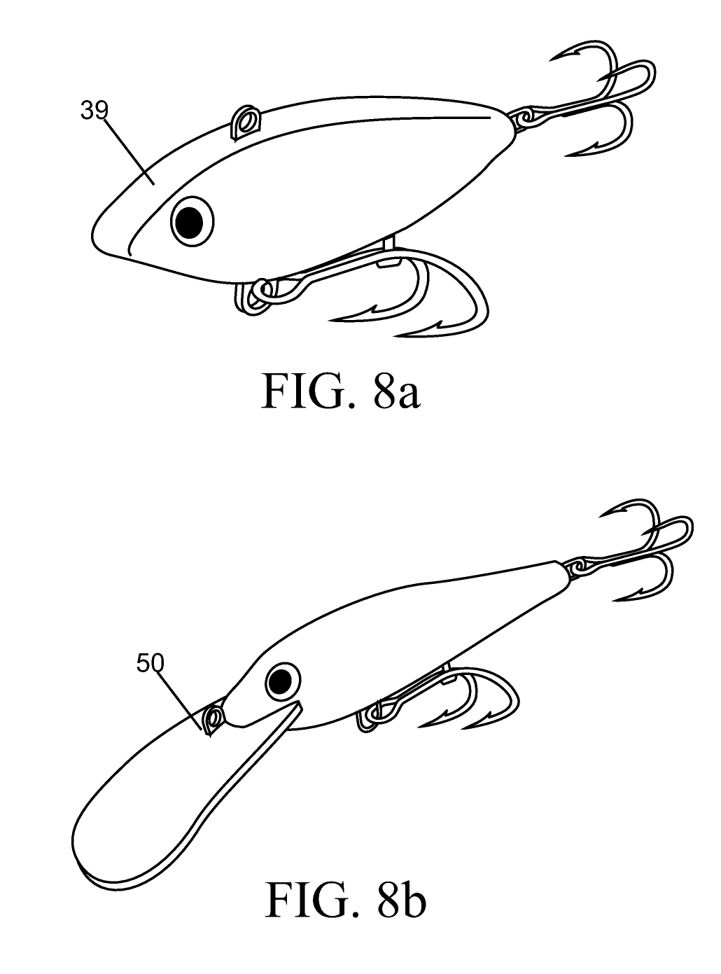

In an alternative arrangement, the hook mounting assembly can be applied to a blade or vibrating fishing lure 35 (FIGS. 7a-d) which is generally made from a combination of stamped metal and cast metal and can include plastic moulding. The lure is pulled through the water via a connection of line directly or indirectly to the upper surface of the lure as shown in the series of holes 36. One or more eye retainers 11 and catches 12 can be incorporated in the blade 35 to receive one or more hook arrays 16.

The hooks can be fitted to the fishing lure or jighead with the hook arrays 16 projecting either towards the lure body or away from the lure body depending on the fishing conditions. For instance, if fishing a waterway that includes numerous underwater obstacles or ‘snags’, the angler can choose to locate the hook arrays facing towards the fishing lure bringing the hook points 17 closer to the lure body to avoid snagging, whilst in open water, the hooks may be reversed to face away from the lure body to maximise exposure and increase the likelihood of catching a fish.

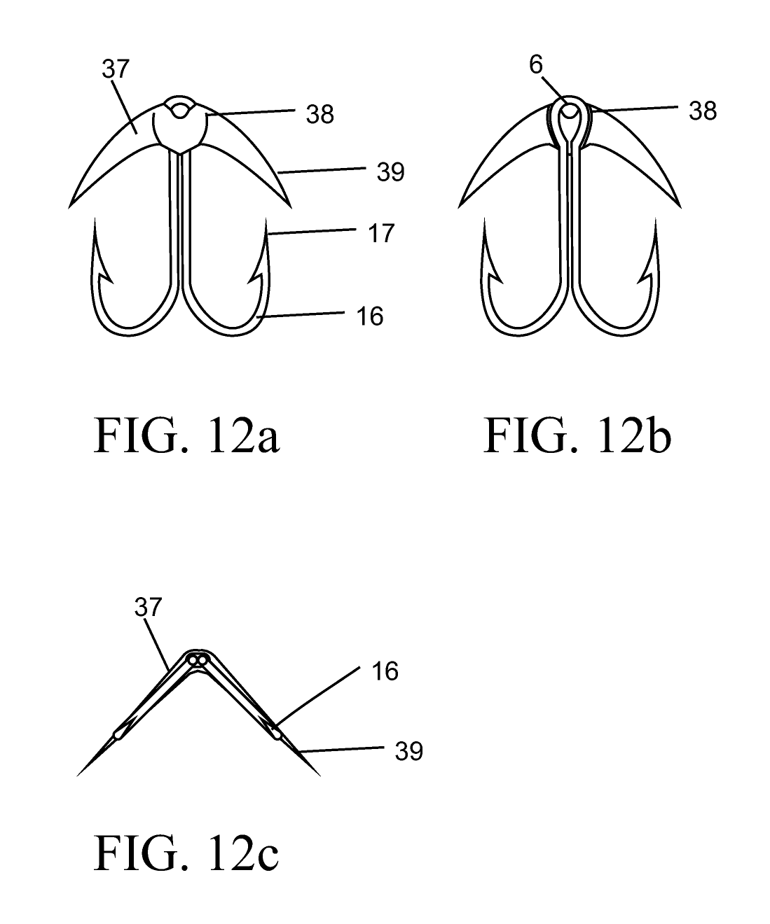

A guard 37 (FIGS. 7a, 12a-12c), can be fitted to the hook array 16 to minimise the likelihood of the hook array 16 from becoming entangled on underwater structure and weed as the lure is pulled forward in general fishing usage. In one arrangement the guard 37 includes a collar 38 which can be fitted relative to the hook eye 6 via a friction or adhesive fit. The guard armature 39 extends outward corresponding to the gape of the hook on the array 16 shielding it from entanglement. The guard 37 is made of a resilient material which will resist the force of objects passing over the wing from entangling with the hook point 17 in normal fishing conditions. If a fish strikes at the lure, the wing will have sufficient flexibility to flex and expose the hook point to hook the fish.

In another arrangement, the guard 37 can locate over the hook point 17, preventing the hook from becoming entangled, but is sufficiently flexible to spring away from the hook point 17 when the guard 37 is struck by a fish, thereby exposing the hook point 17.

The hook mounting assembly can be integrated into hard bodied and soft bodied lures such as a lipless or bibless crankbait 39 or a lipped or bibbed crank bait 50.

Jigheads 33 (FIGS. 9a-i, 10a-c) are traditionally configured to include at one end a single hook 55 which connects to a soft plastic lure body 56 and at the other end includes a hook eye 40. The neck of the hook adjoining the hook eye 40 is generally encased in a lead or weighted casting or moulding 41 to allow it to sink in the water column. The shaft of the single hook 55 often includes ribbing 57 to assist with retaining the soft plastic lure body 56. The soft plastic lure body 56 creates action in the water as the jighead moves through the water.

Hook arrays 16 added to the single hook configuration that are standard with traditional jigheads increase the likelihood of fish being hooked when they strike at the jighead with soft plastic body.

Eye retainers 46 and catch 44 may be connected by and positioned on an arm 42 which in turn is attached to the weighted casting or moulding 41. The configuration can include the eye retainer 46, arm 42 and catch 44 integrally formed in a wire loop. The eye retainer 46 and catch 44 may be on the weighted casting or moulding 41 or alternatively, the eye retainer 46 and/or catch may be on the arm 42 and spaced from the body of the lure or soft plastic tail 56. The spacing of the eye retainer 46, arm 42 and catch 44 integrally formed in a wire loop separates the connection of additional hooks away from the body of the soft plastic bait 56 which is mounted to the traditional single hook 55. This ensures the additional hook array 16 remains separated from the soft plastic such that it does not influence the natural action of the soft plastic bait.

In another arrangement of the jig head 47 (FIG. 90, additional eye retainers 46 and catch assemblies 44 can be added to the unit. This can be in the form of a wire 43 which includes bends that form loops or welded on additions to deliver the eye retaining and catching facilities.

The addition of more hooks via these hook mount assemblies to jigheads 33, swinging jig heads 41, and worm hooks 49 increases the likelihood of hooking and remaining connected to a fish that strikes.

FIGS. 10 a-c show an alternative arrangement for a jig head where a pressed metal or moulded plastic eye retainer and catch are connected.

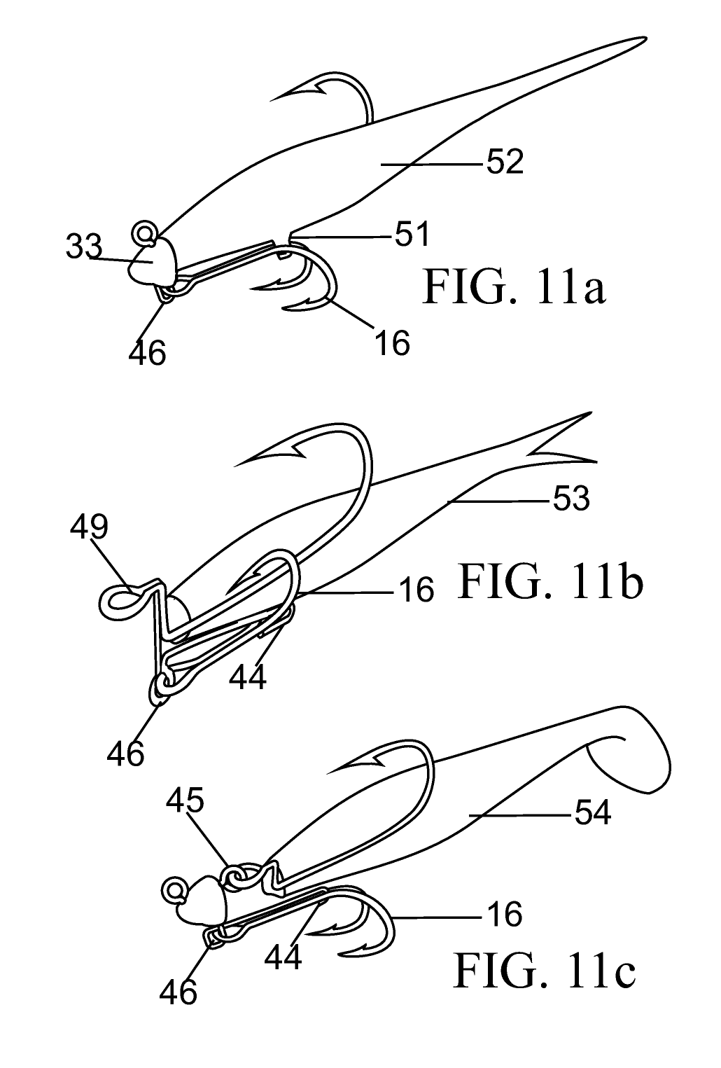

FIG. 11a shows a soft plastic worm tail 52, fitted to a jig head 33. In one arrangement the eye retainer 46 extends from the jig head 33 whilst the catch 51 is a part of the soft plastic tail 52.

FIG. 11b shows a soft plastic tail 53 fitted to a worm hook 49.

FIG. 11c shows a soft plastic vibrating tail 54 fitted to a swinging jig head 45.

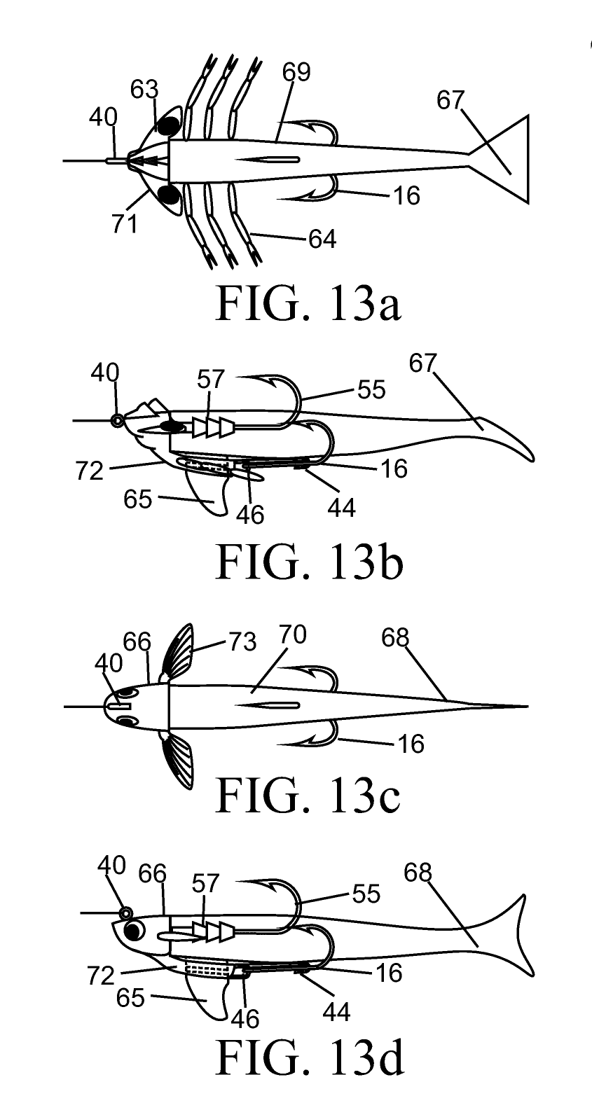

FIG. 13a-b shows an alternative arrangement of a shrimp jighead assembly 69 with soft plastic shrimp tail 67. The jighead assembly 69 includes a moulded head 63 which is shaped to include planers 71 and an undercarriage 72 that is fitted with an eye retainer 46 and wire catch 44. A hook 16 is fitted to the eye retainer 46 and wire catch 44. Legs 64 can moulded into or fitted to the undercarriage 72 to better represent a real shrimp. A hook 55 is moulded to the head 63 and includes retaining profiles 57 to secure a soft plastic shrimp bait 67 in place. The undercarriage 72 extends from the moulded head 63 and is moulded to include the fitment of a weight 65 into its underside via frictional, adhesive engagement or other means.

FIG. 13c-d shows an alternative arrangement of a fish jighead assembly 70 with soft plastic fish tail 68. The jighead assembly 70 includes a moulded head 66 which can be shaped to include fins 73 and an undercarriage 72 that is fitted with an eye retainer 46 and wire catch 44. A hook 16 is fitted to the eye retainer 46 and wire catch 44. A hook 55 is moulded to the head 66 and includes retaining profiles 57 to secure a soft plastic fish bait 68 in place. The undercarriage 72 extends from the moulded head 66 and is moulded to include the fitment of a weight 65 into its underside via frictional, adhesive engagement or other means.

1. A fishing lure for attracting fish species, the fishing lure including;
a body; and
a mounting assembly configured to releasably hold a hook array to the body, the mounting assembly comprising an eye retainer for pivotally retaining an eye of the hook array, and a catch spaced from the eye retainer, the catch adapted to engage two shafts of the hook array; wherein
the catch is shaped to engage and release the hook array subsequent to elastic relative movement between the two shafts.

2. The fishing lure of claim 1 wherein the body comprises a hard body, soft body, a jig head, spinner bait, a blade, a spoon, a hook or portion thereof adapted alone or in combination with another element to act as a bait or a platform for catching fish.

3. The fishing lure of claim 2 wherein the body is formed from one or more of metal, polymeric materials such as soft or hard plastics, timber and epoxy resins.

4. The fishing lure of claim 1 wherein the eye retainer is in the form of a hole, open loop, closed loop, ring, eyelet, clasp or clip, through which the eye of a hook array can pass and locate.

5. The fishing lure of claim 4 wherein the eye retainer is in the form of one or more of a closed loop that extends from the lure body in a hole or slot in the lure body.

6. The fishing lure of claim 1 wherein the catch includes a contact section positioned for first contact with a hook array when loading onto the catch, and a retention section for positioning of the hook array when loaded.

7. The fishing lure of claim 6 wherein the contact section is wider than the inter shaft distance of the two shafts that locate over it and the retention section is narrower than the contact section.

8. The fishing lure of claim 6 wherein the contact section is one or more of a ledge, a cone-shaped head, a wire, a plate or other structure that requires springing of two shafts of the hook array apart in loading.

9. The fishing lure of claim 1 wherein the retention section is one or more of a slot, a hole, a recess, a thinner plate, a waist, a thin plate or wire.

10. The fishing lure of claim 1 wherein the catch is a retaining edge which engages with the hook shafts by elastic deformation of at least one of the shafts and separation by relative movement of the shafts.

11. The fishing lure of claim 1 wherein the catch is formed as a button having a head and waist, the head dimensioned to allow passage of the shafts when separated to retain the shafts in the waist after engagement.

12. The fishing lure of claim 1 wherein the catch is one or more of a hole, groove or slot in the lure body.

13. The fishing lure of claim 1 wherein the catch is made from rigid material.

14. The fishing lure of claim 1 wherein the eye retainer and catch are connected by and positioned on an arm which in turn is attached to the body.

15. The fishing lure of claim 14 wherein the eye retainer, arm and catch are integrally formed and used on a jig head body or worm hook body for use with soft plastic lures.

16. The fishing lure of claim 1 wherein the body includes two or more mounting assemblies.

17. The fishing lure of claim 1 further including at least one hook array.

18. A fishing lure including;
a body; and
a mounting assembly configured to releasably hold a hook array to the body, the mounting assembly comprising an eye retainer for pivotally retaining an eye of the hook array, and a catch spaced from the eye retainer, the catch adapted to engage two shafts of the hook array; wherein
the catch includes a contact section positioned for first contact with a hook array when loading onto the catch, and a retention section for positioning of the hook array when loaded and wherein the contact section is wider than a distance between the two shafts that locate over the contact section and the retention section is narrower than the contact section.

19. A method of releasably positioning a hook array on a lure, the method comprising the steps of:
positioning an eye of the hook array in an eye retainer of the lure,
releasably loading the hook array on a catch of the lure by separating an end of each of two shafts of the hook array while urging the two shafts over a portion of the catch and
allowing the two shafts to resiliently return towards each other and engage the catch.
